(19) United States
(12) Patent Application Publication
(10) Pub. No.: US 2025/0225401 A1
(43) Pub. Date: Jul. 10, 2025

(54) SYSTEMS AND METHODS FOR RESPONSIBLE ARTIFICIAL INTELLIGENCE

(71) Applicant: TEACHERS INSURANCE AND ANNUITY ASSOCIATION OF AMERICA, New York, NY (US)

(72) Inventors: Sastry Vsm Durvasula, Phoenix, AZ (US); Swatee Singh, Livingston, NJ (US); Rares Ioan Almasan, Paradise Valley, AZ (US); Sonam Jha, Short Hills, NJ (US)

(21) Appl. No.: 18/404,155

(22) Filed: Jan. 4, 2024

(51) Int. Cl. G06N 3/09; G06N 3/0475; G06N 3/088

(52) U.S. Cl. CPC G06N 3/09; G06N 3/0475; G06N 3/088

(57) ABSTRACT

The following relates generally to generative artificial intelligence (AI), and more particularly to reducing “hallucinations” in generative AI solutions. In some embodiments, one or more processors: (i) receive an input statement; and (ii) generate a response to the input statement by inputting the input statement into a general adversarial network (GAN), the GAN comprising: (a) a generative network configured to send and receive data to a discriminative network; and (b) the discriminative network configured to send and receive data to the generative network, wherein the discriminative network was trained based on information of at least one domain.

### FIELD

The present disclosure generally relates to generative artificial intelligence (AI), and more particularly relates to reducing “hallucinations” in generative AI solutions.

### BACKGROUND

Companies often seek to offer generative artificial intelligence (AI) solutions related to their products. For example, a company may wish to provide a chatbot to answer customer questions about their company's products. However, in practice, such chatbots often “hallucinate” (e.g., provide incorrect information, etc.) with respect to providing the information about the company's specific products. For example, although some chatbots may hallucinate less when they are asked general questions, they hallucinate more when they are asked more specific questions about specific company products or policies.

The systems and methods disclosed herein provide solutions to this challenge and may provide solutions to the ineffectiveness, insecurities, difficulties, inefficiencies, encumbrances, and/or other drawbacks of conventional techniques.

### SUMMARY

In one aspect, a computer-implemented method for generative artificial intelligence (AI) may be provided. In one example, the method may include: (1) receiving, via one or more processors, an input statement; and (2) generating, via the one or more processors, a response to the input statement by inputting the input statement into a general adversarial network (GAN), the GAN comprising: a generative network configured to send and receive data to a discriminative network; and the discriminative network configured to send and receive data to the generative network, wherein the discriminative network was trained based on information of at least one domain, wherein the at least one domain includes at least one of: retirement; cyber; legal; compliance; human resources; privacy; or fairness. The method may include additional, fewer, or alternate actions, including those discussed elsewhere herein.

In another aspect, a computer system for generative artificial intelligence (AI) may be provided. In one example, the computer system may include one or more processors configured to: (1) receive an input statement; (2) generate a response to the input statement by inputting the input statement into a general adversarial network (GAN), the GAN comprising: a generative network configured to send and receive data to a discriminative network; and the discriminative network configured to send and receive data to the generative network, wherein the discriminative network was trained based on information of at least one domain, wherein the at least one domain includes at least one of: retirement; cyber; legal; compliance; human resources; privacy; or fairness. The computer system may include additional, less, or alternate functionality, including that discussed elsewhere herein.

In yet another aspect, a computer device for generative artificial intelligence (AI) may be provided. In one example, the computer device may include: one or more processors; and/or one or more non-transitory memories coupled to the one or more processors. The one or more memories including computer executable instructions stored therein that, when executed by the one or more processors, may cause the one or more processors to: (1) receive an input statement; (2) generate a response to the input statement by inputting the input statement into a general adversarial network (GAN), the GAN comprising: a generative network configured to send and receive data to a discriminative network; and the discriminative network configured to send and receive data to the generative network, wherein the discriminative network was trained based on information of at least one domain, wherein the at least one domain includes at least one of: retirement; cyber; legal; compliance; human resources; privacy; or fairness. The computer device may include additional, less, or alternate functionality, including that discussed elsewhere herein.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 illustrates an exemplary computer system for training and/or applying a generative adversarial network (GAN) in which the exemplary computer-implemented methods described herein may be implemented.

FIG. 2 illustrates an overview of an example diagram for training and/or applying a GAN.

FIG. 3 illustrates an example input system.

FIG. 4 illustrates an example generative AI models repository.

FIG. 5 illustrates an example domain documents system.

FIG. 6 illustrates an example reinforcement learning with human feedback.

FIG. 7 illustrates an example engine.

FIG. 8A illustrates an example GAN.

FIG. 8B illustrates an example operation of an example GAN including multiple discriminative networks.

FIG. 9 depicts an example screen allowing a subject matter expert to approve, reject or modify a candidate response.

FIG. 10 shows an exemplary computer-implemented method or implementation for training and/or applying a GAN.

FIG. 11 depicts an example screen of a customer computing device including an input statement including a question.

FIG. 12 depicts an example screen of a customer computing device including an input statement including a request for more information.

FIG. 13 illustrates an example method of generating one or more alerts.

### DETAILED DESCRIPTION

Companies often seek to offer generative artificial intelligence (AI) solutions related to their products. For example, a company may wish to provide a chatbot to answer customer questions about their company's products. However, in practice, such chatbots often “hallucinate” (e.g., provide incorrect information, etc.) with respect to providing the information about the company's specific products. For example, although some chatbots may hallucinate less when they are asked general questions, they hallucinate more when they are asked more specific questions about specific company products or policies.

The systems and methods described herein may provide solutions to this challenge and others. For example, according to embodiments described herein, a generative adversarial network (GAN) may be formed. The GAN may include two (or more) networks: a generative network, and a discriminative network. The generative network may generate data, such as an answer to a customer question. The discriminator network may then evaluate the data generated by the generative network, and then determine whether the generated data should pass or fail (e.g., determine if the response generated by the generative network should pass or fail). In some examples, the generative network is trained on general information, whereas the discriminator network is trained on domain information of a particular company (e.g., a company that provides retirement information may include a domain of retirement). Advantageously, the training the GAN in this way, and, in particular, training the discriminative network in this way, decreases hallucinations, thereby improving system functioning.

### Example System

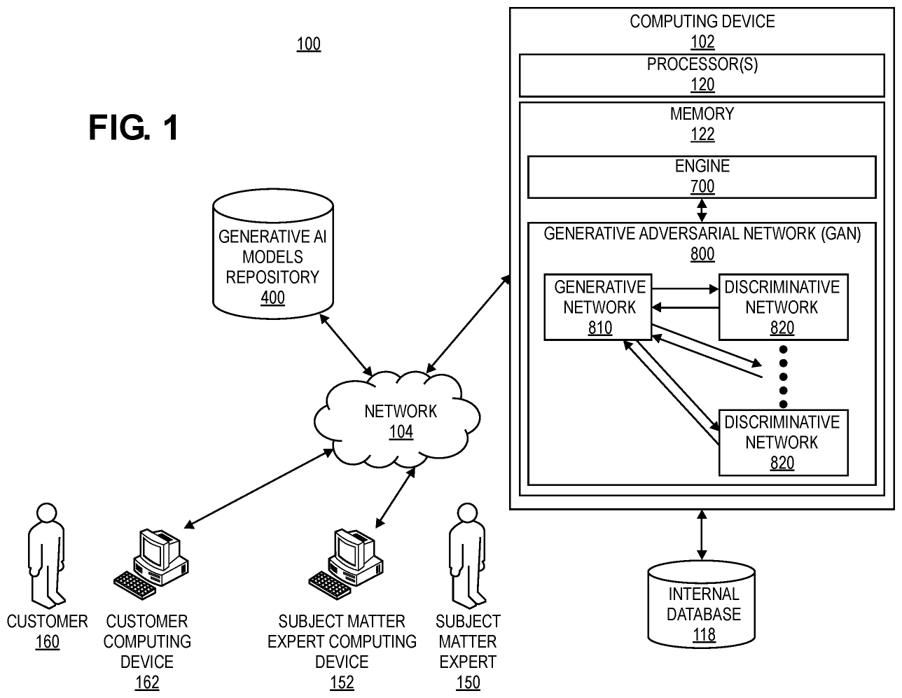

To this end, FIG. 1 illustrates an exemplary computer system 100 for training and/or implementing a generative adversarial network (GAN). The high-level architecture includes both hardware and software applications, as well as various data communications channels for communicating data between the various hardware and software components.

The computing device 102 may include one or more processors 120 such as one or more microprocessors, controllers, and/or any other suitable type of processor. The computing device 102 may further include a memory 122 (e.g., volatile memory, non-volatile memory) accessible by the one or more processors 120, (e.g., via a memory controller). The one or more processors 120 may interact with the memory 122 to obtain and execute, for example, computer-readable instructions stored in the memory 122. Additionally or alternatively, computer-readable instructions may be stored on one or more removable media (e.g., a compact disc, a digital versatile disc, removable flash memory, etc.) that may be coupled to the insurance server 102 to provide access to the computer-readable instructions stored thereon. In particular, the computer-readable instructions stored on the memory 122 may include instructions for executing various applications.

In operation, the computing device 102 may train and/or apply GAN 800. In some examples, the GAN 800 comprises or is comprised in a chatbot and/or voicebot. The GAN 800 may include a generative network 810 and/or discriminative network(s) 820, which will be described in more detail elsewhere herein.

The system 100 may further include generative AI repository 400. In some embodiments, the generative AI repository 400 stores and/or selects a generative AI model. The computing device 102 may retrieve one or more AI models from the generative AI repository 400 to comprise or be comprised in the generative network 810.

In some embodiments, a subject matter expert 150 may aide in the training of the GAN 800. In the example of FIG. 1, the subject matter expert 150 is a human. However, it should be understood that, in some embodiments, the subject matter expert 150 may be a computing device and/or an algorithm (e.g., an AI algorithm, etc.) that approves (or disapproves) responses sent to or generated by the GAN 800.

The subject matter expert 150 may use a subject matter expert computing device 152. The subject matter expert computing device 152 may be any suitable device, such as a computer, a mobile device, a smartphone, a laptop, a phablet, a chatbot or voice bot, etc. The subject matter expert computing device 152 may include one or more display devices, one or more processors, one or more memories, etc.

The subject matter expert 150 (whether human or computer) may be an expert in a particular domain. For example, the subject matter expert 150 may be an expert in any of the following domains: retirement, cyber, legal, compliance, human resources, privacy, or fairness.

Additionally or alternatively to the subject matter expert 150 training the GAN 800, information from the internal database 118 may be used to train the GAN 800. For example, information of domains (e.g., retirement, cyber, legal, compliance, human resources, privacy, or fairness) stored at the internal database 118 may be used to train the GAN 800. Advantageously, training the GAN 800 based on the domain information reduces hallucinations.

In practice, a customer 160 may generate an input statement (e.g., a question about a company product and/or service, such as a question about a retirement plan). Examples of the customer 160 include an employee of an institution (e.g., a person working for an institution seeking advice for the institution about various retirement plans, etc.), consultants (e.g., an individual hired by an institution to provide advice about various retirement plans, etc.), and an individual (e.g., an individual with a retirement account seeking advice related to the retirement account, etc.).

The customer 160 may use a customer computing device 162. The customer computing device 162 may be any suitable device, such as a computer, a mobile device, a smartphone, a laptop, a phablet, a chatbot or voice bot, etc. The customer computing device 162 may include one or more display devices, one or more processors, one or more memories, etc.

In addition, although the example of FIG. 1 illustrates the GAN 800 as on the computing device 102, it should be understood that, additionally or alternatively, the GAN 800 may be on the customer computing device 162 and/or subject matter expert computing device 152.

In addition, further regarding the example system 100, the illustrated exemplary components may be configured to communicate, e.g., via a network 104 (which may be a wired or wireless network, such as the internet), with any other component. Furthermore, although the example system 100 illustrates only one of each of the components, any number of the example components are contemplated (e.g., any number of computing devices, subject matter expert computing devices, customer computing devices, generative AI model repositories, GANs, generative networks, internal databases, etc.).

### Example Architecture

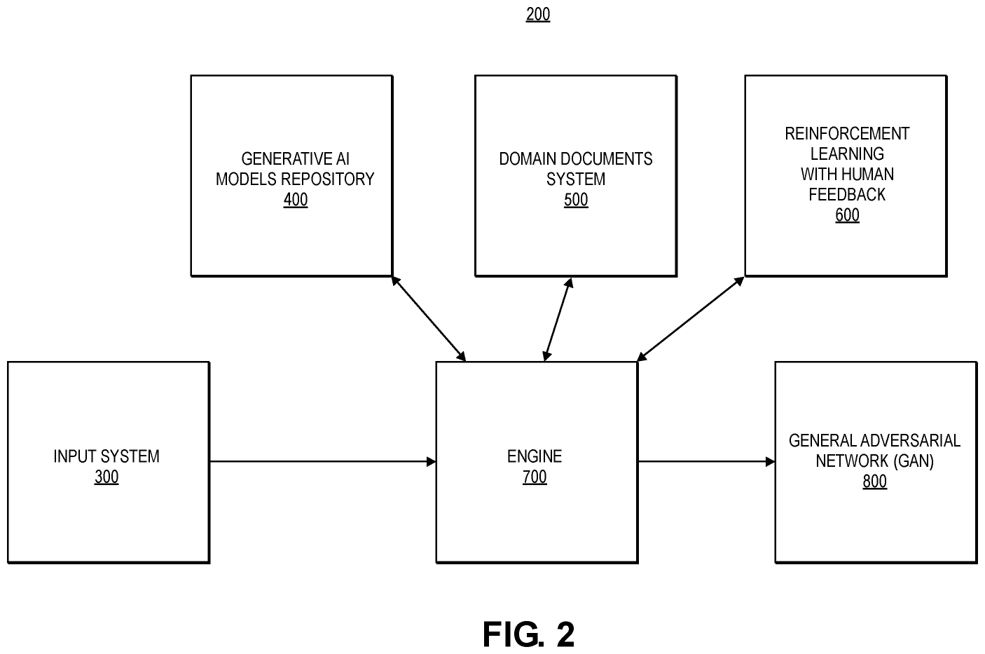

FIG. 2 illustrates an overview of an example diagram 200 for training and/or applying a generative adversarial network (GAN).

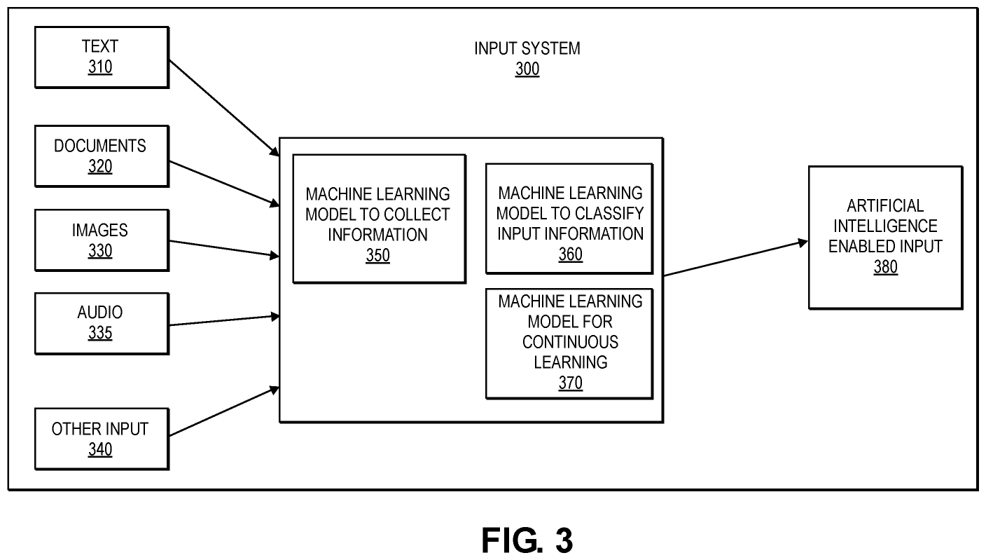

In some embodiments, the example diagram 200 may begin with input system 300. A more detailed view of an example input system 300 is illustrated by FIG. 3. With reference to FIG. 3, the example input system block 300 may include receiving an input statement, such as text 310, documents 320, images 330, audio 335 or other input 340.

The input system 300 may further include ML model to collect information 350 (e.g., collect any of the input statements 310, 320, 330, 335, 340). Once collected, the information may be sent to the ML model to classify input information 360, which may classify input statements into one or more domains.

Examples of domains include: retirement, cyber, legal, compliance, human resources, privacy, and/or fairness. For example, the input statement “what retirement programs does company XYZ offer” would be in the retirement domain.

The cyber domain may include technology related input statements. Likewise, the legal domain may include legal related input statements. The compliance domain may include compliance related input statements (e.g., compliance with regulations, etc.). The human resources domain may include human resource related input statements. The privacy domain may include privacy related input statements. The fairness domain may include fairness related input statements.

The input system 300 may further include ML model for continuous learning 370. This model may be used to continuously improve the domain classification. For example, a human (e.g., the subject matter expert 150) may correct a domain (or add an additional domain) that the ML model to classify input information 360 indicated for an input statement, and this feedback may be used to continuously improve the domain classification.

The input system 300 may further include AI enabled input 380. In some examples, the AI enabled input 380 comprises the input statement along with the domain classification(s).

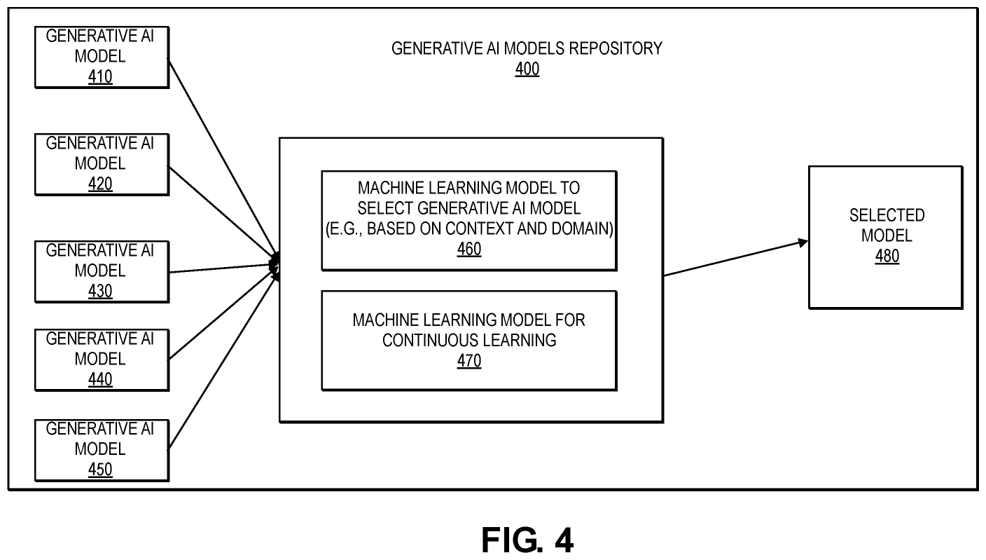

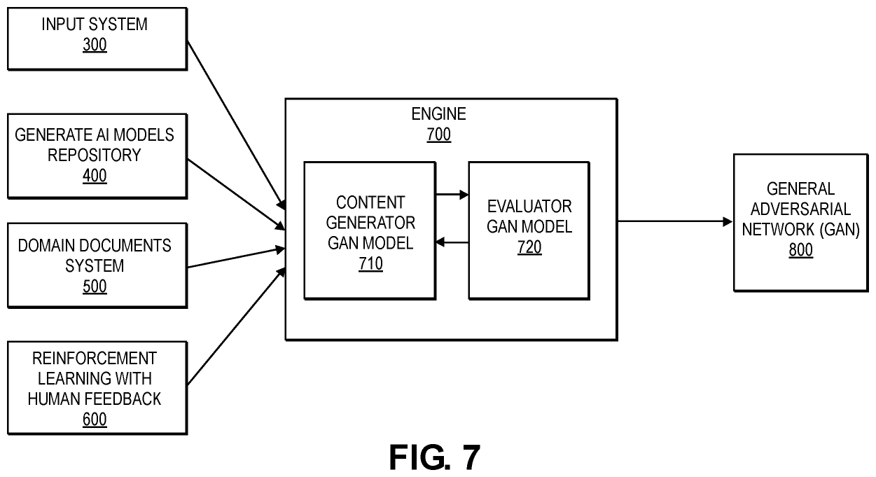

Returning to FIG. 2, the input system 300 may feed data to the engine 700, which will be described in more detail elsewhere herein (e.g., with respect to FIG. 7). The engine 700 may also receive an input from the generative AI models repository 400. A more detailed view of an example generative AI models repository 400 is illustrated by the example of FIG. 4. With reference thereto, the example generative AI models repository 400 may include generative AI models 410, 420, 430, 440, 450. Examples of generative AI models include GOOGLE PALM2; AMAZON TITAN; etc.

The generative AI models repository 400 may further include ML model to select generative AI model 460. In some embodiments, the ML model to select generative AI model 460 may select a generative AI model based on context and type of data.

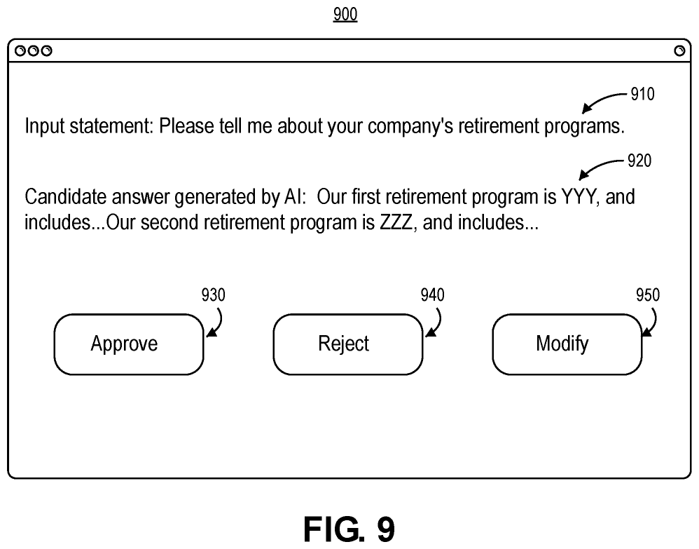

The generative AI models repository 400 may further include ML model for continuous learning 470. In some embodiments, the ML model for continuous learning 470 may facilitate continuous learning by receiving feedback on how the generative AI models 410-450 are performing. For example, the ML model for continuous learning 470 may receive feedback from the subject matter expert (e.g., via the screen 900 of FIG. 9) about if answer(s) from generative AI models 410-450 are being approved or rejected. In another example, the ML model for continuous learning 470 may receive feedback indicating approvals/rejections from the evaluator GAN model 720 and/or the discriminative network 820. The ML model for continuous learning 470 may then use this feedback to improve the machine learning model to select generative AI model 460, thereby advantageously improving performance of the system.

The generative AI models repository 400 may further include selected model 480. In some embodiments, the selected model 480 may be selected from one or more of the generative AI models 410, 420, 430, 440, 450.

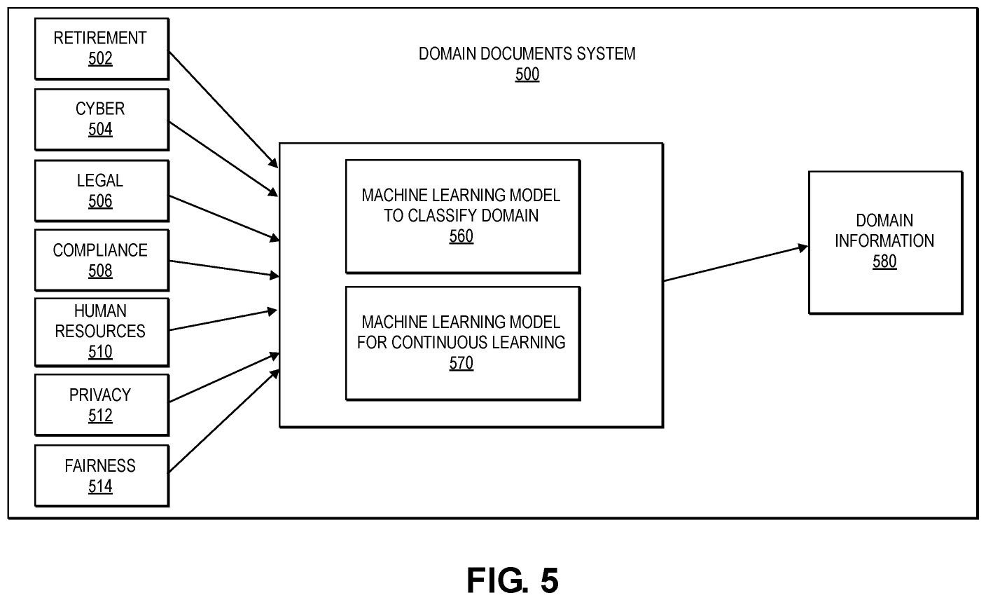

Returning to FIG. 2, the engine 700 may further receive data from domain documents system 500. In some embodiments, the domain documents system 500 may be part of the internal database 118. A more detailed view of an example domain documents system 500 is illustrated by FIG. 5. With reference thereto, the domain documents system 500 may include or receive data or documents corresponding to different domains. In the illustrated example, this is depicted by retirement 502, cyber 504, legal 506, compliance 508, human resources 510, privacy 512, and fairness 514. The domain documents system 500 may further include ML model to classify domain 560, which may classify input statements into any of the domains.

The domain documents system 500 may further include ML model for continuous learning 570, which may receive information to further train the ML model to classify domain 560. For example, the subject matter expert 150 may provide feedback on whether input statements have been classified another correct domain, which the ML model for continuous learning 570 may use for the training.

The domain documents system 500 may further include domain information 580 (e.g., the output of the machine learning model to classify domain 560).

Returning again to FIG. 2, the engine 700 may use any received inputs to build (e.g., train) the GAN 800. In some embodiments, the engine 700 trains the content generator GAN model 710 to become the generative network 810, and trains the evaluator GAN model 720 to become the discriminative network 820, thereby forming the GAN 800.

In some examples, the GAN 800 is trained via a zero-sum game including an objective function wherein the content generator GAN model 710 aims to minimize the objective, and the evaluator GAN model 720 aims to maximize the objective. In one such example, the objective function is:

$$L ( {μ}_{G} , {μ}_{D} ) := {𝔼}_{x \sim {μ}_{ref} , y \sim {μ}_{D} ( x )} [ ln y ] + {𝔼}_{x \sim {μ}_{G} , y \sim {μ}_{D} ( x )} [ ln ( 1 - y ) ]$$

In this example, the task of the content generator GAN model 710 is to approach μ_{G}≈μ_{ref}. In other words, the task of the content generator GAN model 710 is to match its own distribution as closely as possible to the reference distribution. On the other hand, the task of the evaluator GAN model 720 is to output a value close to 1 when the input appears to be from the reference distribution, and to output a value close to 0 when the input appears that it came from the generator distribution, thereby approving or rejecting the input.

Put another way, in some examples, the content generator GAN model 710 generates candidates (e.g., candidate responses to input statements) while the evaluator GAN model 720 evaluates them (e.g., approves or rejects them). Such a contest may operate in terms of data distributions. For example, the content generator GAN model 710 may learn to map from a latent space to a data distribution of interest, while the evaluator GAN model 720 distinguishes candidates produced by the generator from the true data distribution. The content generator GAN model's 710 training objective is to increase the error rate of the evaluator GAN model 720, thereby “fooling” the evaluator GAN model 720 by producing novel candidates that the evaluator GAN model 720 thinks are not synthesized (are part of the true data distribution). It should be understood that this may be an unsupervised learning process.

In some embodiments, the engine 700 starts with the selected model 480 as the content generator GAN model 710, and then trains one or both of the content generator GAN model 710 and/or the evaluator GAN model 720 based on the domain information 580 (such as domain information of at least one of retirement; cyber; legal; compliance; human resources; privacy; and/or fairness). Advantageously, training the evaluator GAN model 720 based on the domain information 580 reduces hallucinations.

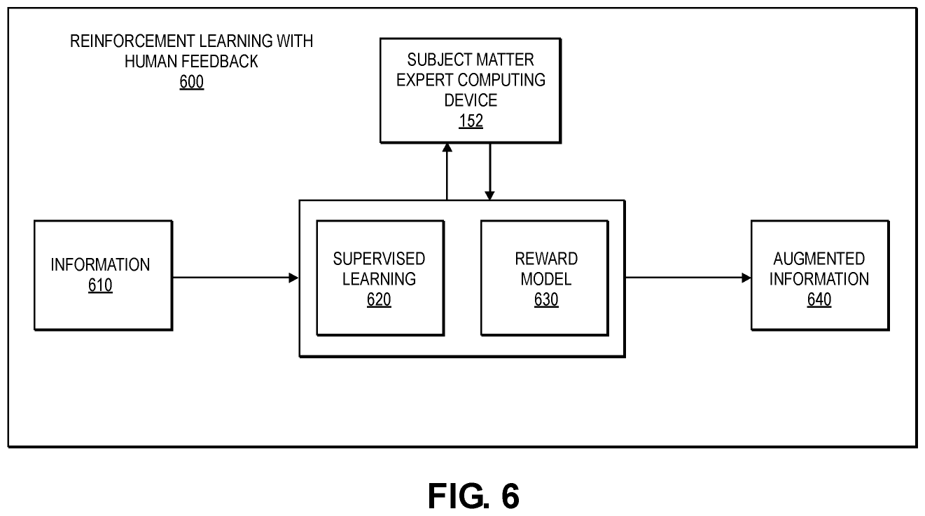

To further facilitate training, the engine 700 may interact with reinforcement learning with human feedback 600. A more detailed view of an example reinforcement learning with human feedback 600 is illustrated by FIG. 6. With reference thereto, the reinforcement learning with human feedback 600 may receive information 610, which may be any suitable information. For example, the information 600 may be data sent from the engine 700 (and/or from the input system 300) and/or may include a candidate response generated by the engine 700 (e.g., by the content generator GAN model 710).

In some embodiments, supervised learning 620 is used to train the reward model 630. In some such examples, the content generator GAN model 710 generates a candidate response to an input statement (e.g., received from the input system 300). The generated candidate response may be presented to the subject matter expert 150 via the subject matter expert computing device 152, such as in the example of FIG. 9. More particularly, FIG. 9 depicts example screen 900 of the subject matter expert computing device 152 allowing the subject matter expert 150 to approve, reject or modify the candidate response 920 (e.g., via the buttons 930, 940, 950). For reference, the input statement 910 may also be displayed. Thus, in some examples, the candidate responses are tagged as approved (e.g., pass) or rejected (e.g., fail), which may be used to further train the reward model 630, or sent back to the engine 700 to further train the content generator GAN model 710 and/or evaluator GAN model 720.

The augmented information 640 may be sent back to the engine 700. The augmented information 640 may include, for example, the tagged candidate responses, the reward model 630, etc.

In some embodiments, additionally or alternatively to a supervised learning process (e.g., as described with respect to the reinforcement learning with human feedback 600), the engine 700 may implement an unsupervised learning process (e.g., as described above with respect to the objective function, etc.). For example, in one exemplary unsupervised learning process, the content generator GAN model 710 may generate candidate responses to input statements, which are approved or rejected by the evaluator GAN model 720. Advantageously, training in two phases, a first phase including supervised learning, and a second phase (subsequent to the first phase) including unsupervised learning has been found to improve accuracy of the system, thereby improving technical functioning.

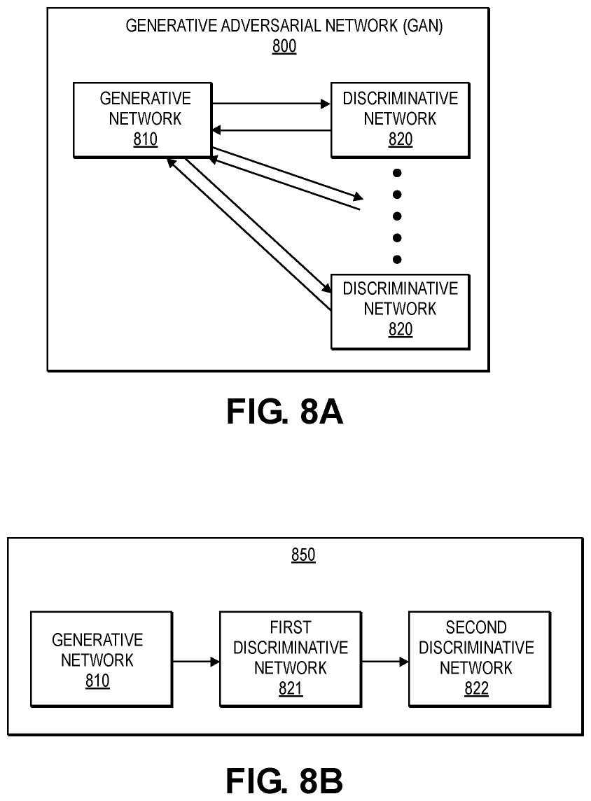

Furthermore, in some embodiments, more than one evaluator GAN model 720 may be trained. For example, different evaluator GAN models 720 may be trained for different domains. Each evaluator GAN model 720 may form a different discriminative network 820 in the GAN 800. In operation, the discriminative networks 820 may operate sequentially, each passing or failing a response generated by the generative network 810. For instance, FIG. 8B shows an example operation 850 including multiple discriminative networks. The generative network 810 may generate a response which is first approved or rejected by the first discriminative network 821. If the first discriminative network 821 approves the response, it is evaluated by the second discriminative network 822 for approval or rejection. If the response is approved by the second discriminative network 822, the response may be presented to the customer 160 (e.g., via the customer computing device 162).

### Example Methods

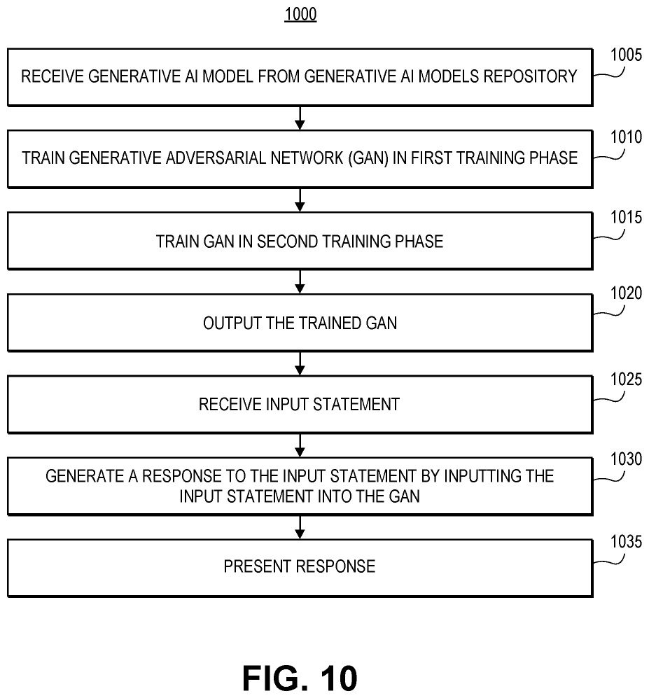

FIG. 10 shows an exemplary computer-implemented method or implementation 1000 for training and/or applying a GAN. Although the following discussion refers to the exemplary method or implementation 1000 as being performed by the one or more processors 120, it should be understood that any or all of the blocks may be alternatively or additionally performed by any other suitable component as well (e.g., one or more processors of the subject matter expert computing device 152, one or more processors of the customer computing device 162, etc.).

The example method or implementation 1000 may begin at block 1005 when the one or more processors 120 receive a generative AI model from the generative AI models repository 400. The one or more processors 120 may set the received generative AI model to be the content generator GAN model 710.

At block 1010, the one or more processors 120 may train the GAN in a first training phase. In some examples, the first training phase is a supervised training phase. For example, as described above, the content generator GAN model 710 may generate answers to input statements, which the subject matter expert 150 may approve, reject, or modify, such as in the example of FIG. 9. In this way, one or both of the content generator GAN model 710 and/or the evaluator GAN model 720 may be trained.

Additionally or alternatively, at block 1010, the content generator GAN model 710 and/or the evaluator GAN model 720 may be trained with domain information 580 (such as domain information of at least one of retirement; cyber; legal; compliance; human resources; privacy; and/or fairness). For example, the domain information may include: (i) historical input statements (e.g., requests for information, questions, etc.) corresponding to a particular domain, and (ii) historical responses to the historical input statements. Advantageously, training the evaluator GAN model 720 based on the domain information 580 reduces hallucinations.

At block 1015, the one or more processors 120 may train the GAN in a second training phase. In some examples, the second training phase is an unsupervised training phase. For example, as described above, the GAN may be trained via a zero-sum game including an objective function wherein the content generator GAN model 710 aims to minimize the objective, and the evaluator GAN model 720 aims to maximize the objective. In this way, one or both of the content generator GAN model 710 and/or the evaluator GAN model 720 may be trained.

Additionally or alternatively, at block 1015, the content generator GAN model 710 and/or the evaluator GAN model 720 may be trained with domain information 580 (such as domain information of at least one of retirement; cyber; legal; compliance; human resources; privacy; and/or fairness). For example, the domain information may include: (i) historical input statements (e.g., requests for information, questions, etc.) corresponding to a particular domain, and (ii) historical responses to the historical input statements. Advantageously, training the evaluator GAN model 720 based on the domain information 580 reduces hallucinations.

It should be appreciated that in embodiments including more than one discriminative network 820, such as illustrated in the example of FIG. 8B, blocks 1010 and/or 1015 may be iterated through to train each discriminative network 820. For example, blocks 1010 and/or 1015 may be iterated through to train evaluator GAN models 720 that will become the discriminative networks 820.

At block 1020, the one or more processors 120 output the trained GAN model 800. For example, the engine 700 may set the trained content generator GAN model 710 to be the generative network 810, and set the trained evaluator GAN model 720 to be the discriminative network 820.

At block 1025, the one or more processors 120 may receive an input statement. Examples of the input statement include text 310, documents 320, images 330, audio 335, and/or other input 340. The input statement may be received from any suitable component, such as the customer computing device 162, the subject matter expert computing device 152, the generative AI server 170, etc.

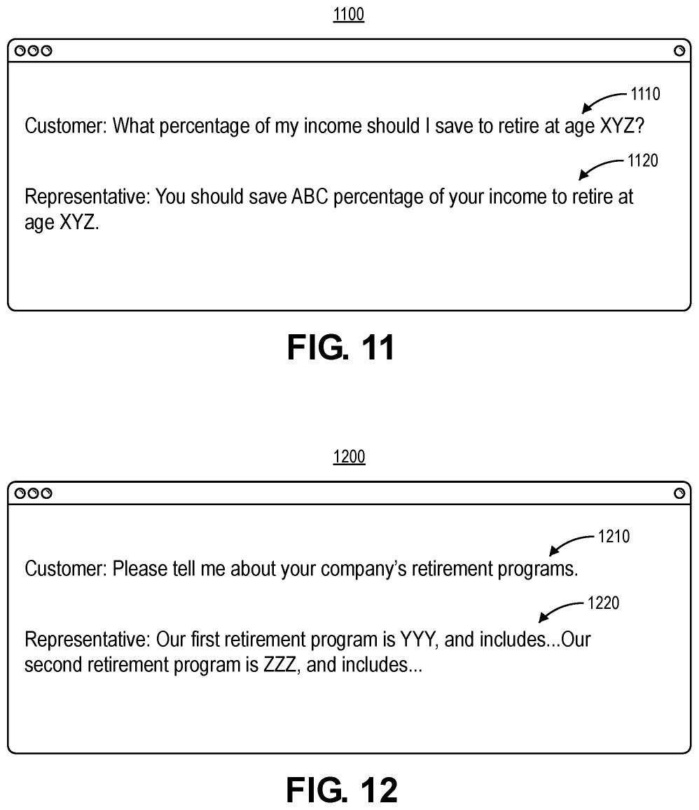

In some examples, the input statement includes a question. In this regard, FIG. 11 depicts an example screen 1100 of the customer computing device 162. With reference thereto, the customer 160 has entered input statement 1110, which includes a question: “What percentage of my income should I save to retire at age XYZ?”

In some examples, the input statement includes a request for more information. In this regard, FIG. 12 depicts an example screen 1200 of the customer computing device 162. With reference thereto, the customer 160 has entered input statement 1210, which includes a request for more information: “Please tell me about your company's retirement programs.”

At block 1030, the one or more processors 120 may generate a response to the input statement by inputting the input statement into the GAN 800. The GAN 800 is described elsewhere herein.

At block 1035, the response generated at block 1030 may be presented (e.g., to the customer 160 via the customer computing device 162, etc.). The presentation may be made via any suitable technique. For example, the presentation may include displaying the response on any display (e.g., a display of the customer computing device 162, a display of the subject matter expert computing device 152, etc.). Additionally or alternatively, the response may be delivered in auditory form (e.g., via the customer computing device 162, the subject matter expert computing device 152, etc.).

For example, with respect to FIG. 11, the customer 160 is presented with the response 1120 (e.g., an answer to the question), “You should save ABC percentage of your income to retire at age XYZ.” In another example, with respect to FIG. 12, the customer 160 is presented with the response 1220, “Our first retirement program is YYY, and includes . . . . Our second retirement program is ZZZ, and includes . . . . ”

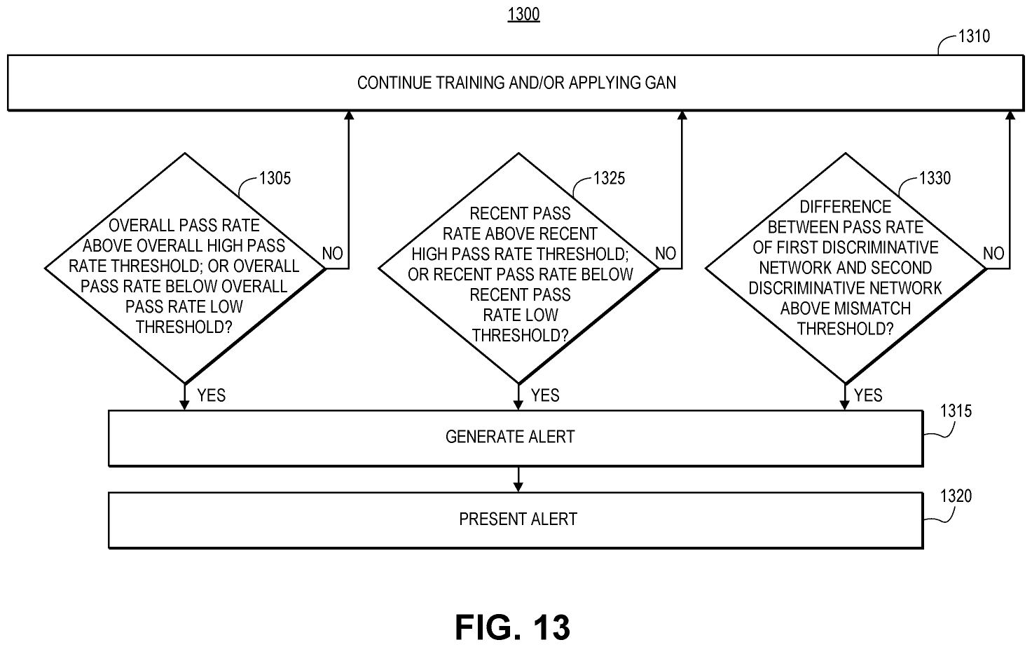

In addition, advantageously, at any point in the example method 1000, alerts may be generated. Said another way, while performing the example method 1000, the one or more processors 120 may continuously determine if alerts should be generated. FIG. 13 illustrates an example method 1300 of generating one or more alerts. At decision block 1305, the one or more processors 120 determine if an overall pass rate of a discriminative network 820 is above an overall high pass rate, or is below an overall pass rate low threshold (e.g., if the pass rate is inside an acceptable pass rate range). In this way, the one or more processors 120 determine if the pass rate has gradually reached a point of being outside of an acceptable range. If so, it could mean that a human, such as the subject matter expert 150, should intervene to correct errors in the discriminative network 820.

If the answer at decision block 1305 is no, the one or more processors 120 may continue training and/or applying the GAN 800 at block 1310. If the answer is yes, the one or more processors 120 generate an alert at block 1315.

At block 1320, the alert may be presented (e.g., to the customer 160 via the customer computing device 162, etc.). The presentation may be made via any suitable technique. For example, the presentation may include displaying the alert on any display (e.g., a display of the subject matter expert computing device 152, a display of the customer computing device 162, etc.). Additionally or alternatively, the indication may be delivered in auditory form (e.g., via the subject matter expert computing device 152, the customer computing device 162, etc.).

At decision block 1325, the one or more processors 120 determine if a recent pass rate of a discriminative network 820 is above a recent high pass rate, or is below a recent pass rate low threshold (e.g., if the pass rate is inside an acceptable pass rate range). In this way, the one or more processors 120 determine if there has been a “spike” in the pass rate. If so, it could mean that a human, such as the subject matter expert 150, should intervene to correct errors in the discriminative network 820. Here, “recent” should be understood to mean a particular number of evaluations done by the discriminative network 820 (or evaluator GAN model 720). For example, recent may be the past 5 evaluations, 10 evaluations, 20 evaluations, 100 evaluations, 1000 evaluations, etc.

If the answer at decision block 1325 is no, the method proceeds to block 1310. If the answer is yes, the method proceeds to blocks 1315 and 1320.

At decision block 1325, the one or more processors 120 determine if a difference between a pass rate of a first discriminative network 821 and a pass rate of the second discriminative network 822 is above a predetermined mismatch threshold. In response to the determination that the difference between the pass rate of the first discriminative network 821 and the pass rate of the second discriminative 822 network is above the predetermined mismatch threshold, an alert may be generated (block 1315), and presented (block 1320). This alert has certain advantages. For example, to a human observing a GAN with multiple discriminative networks, such as in the example of FIG. 8B, it may not be easy to tell that a particular discriminative network is responsible for most of the rejections. For instance, to a human observer observing the GAN, it may seem that each discriminative network is rejecting inputs in approximately equal numbers. Advantageously, this alert may inform the human that corrective action should be taken with respect to a particular discriminative network within the GAN.

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal and/or flowcharts may include additional, less, or alternate functionality, including that discussed elsewhere herein.

### Other Matters

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112 (f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for generative artificial intelligence (AI), the method comprising:
receiving, via one or more processors, an input statement; and
generating, via the one or more processors, a response to the input statement by inputting the input statement into a general adversarial network (GAN), the GAN comprising:
a generative network configured to send and receive data to a discriminative network; and
the discriminative network configured to send and receive data to the generative network, wherein the discriminative network was trained based on information of at least one domain, wherein the at least one domain includes at least one of:
retirement;
cyber;
legal;
compliance;
human resources;
privacy; or
fairness.

2. The computer-implemented method of claim 1, wherein: (i) the input statement includes a question or a request for information, and (ii) the generated response includes an answer to the question or a response to the request for more information.

3. The computer-implemented method of claim 1, further comprising training, via the one or more processors, the discriminative network by inputting the information of the at least one domain into the discriminative network.

4. The computer-implemented method of claim 1, further comprising training, via the one or more processors, the discriminative network (i) in a first phase comprising a supervised training process, and (ii) a second phase comprising an unsupervised training process.

5. The computer-implemented method of claim 1, further comprising displaying, via the one or more processors, on a display, the generated response.

6. The computer-implemented method of claim 1, wherein:
the discriminative network is a first discriminative network;
the at least one domain is a first at least one domain; and
the GAN further comprises a second discriminative network, wherein the second discriminative network was trained based on information of a second at least one domain, wherein the second at least one domain: (i) is different than the first at least one domain, and (ii) includes at least one of:
retirement;
cyber;
legal;
compliance;
human resources;
privacy; or
fairness.

7. The computer-implemented method of claim 6, further comprising:
detecting, via the one or more processors, that the a difference between a pass rate of the first discriminative network and a pass rate of the second discriminative network is above a predetermined mismatch threshold; and
in response to the detecting that the difference between the pass rate of the first discriminative network and the pass rate of the second discriminative network is above the predetermined mismatch threshold, generate, via the one or more processors, an alert.

8. A system for generative artificial intelligence (AI), comprising one or more processors configured to:
receive an input statement; and
generate a response to the input statement by inputting the input statement into a general adversarial network (GAN), the GAN comprising:
a generative network configured to send and receive data to a discriminative network; and
the discriminative network configured to send and receive data to the generative network, wherein the discriminative network was trained based on information of at least one domain, wherein the at least one domain includes at least one of:
retirement;
cyber;
legal;
compliance;
human resources;
privacy; or
fairness.

9. The system of claim 8, wherein: (i) the input statement includes a question or a request for information, and (ii) the generated response includes an answer to the question or a response to the request for more information.

10. The system of claim 8, wherein the one or more processors are further configured to:
train the discriminative network by inputting the information of the at least one domain into the discriminative network.

11. The system of claim 8, wherein one or more processors are further configured to:
train the discriminative network (i) in a first phase comprising a supervised training process, and (ii) a second phase comprising an unsupervised training process.

12. The system of claim 8 further comprising a display, and wherein the one or more processors are further configured to display the generated response on the display.

13. The system of claim 8, wherein:
the discriminative network is a first discriminative network;
the at least one domain is a first at least one domain; and
the GAN further comprises a second discriminative network, wherein the second discriminative network was trained based on information of a second at least one domain, wherein the second at least one domain: (i) is different than the first at least one domain, and (ii) includes at least one of:
retirement;
cyber;
legal;
compliance;
human resources;
privacy; or
fairness.

14. The system of claim 13, wherein the one or more processors are further configured to:
detect if a difference between a pass rate of the first discriminative network and a pass rate of the second discriminative network is above a predetermined mismatch threshold; and
if the difference between the pass rate of the first discriminative network and the pass rate of the second discriminative network is above the predetermined mismatch threshold, generate an alert.

15. A computer device for generative artificial intelligence (AI), the computer device comprising:
one or more processors; and
one or more non-transitory memories, the one or more non-transitory memories having stored thereon computer-executable instructions that, when executed by the one or more processors, cause the one or more processors to:
receive an input statement; and
generate a response to the input statement by inputting the input statement into a general adversarial network (GAN), the GAN comprising:
a generative network configured to send and receive data to a discriminative network; and
the discriminative network configured to send and receive data to the generative network, wherein the discriminative network was trained based on information of at least one domain, wherein the at least one domain includes at least one of:
retirement;
cyber;
legal;
compliance;
human resources;
privacy; or
fairness.

16. The computer device of claim 15, wherein: (i) the input statement includes a question or a request for information, and (ii) the generated response includes an answer to the question or a response to the request for more information.

17. The computer device of claim 15, the one or more non-transitory memories having stored thereon computer executable instructions that, when executed by the one or more processors, cause the one or more processors to:
train the discriminative network by inputting the information of the at least one domain into the discriminative network.

18. The computer device of claim 15, the one or more non-transitory memories having stored thereon computer executable instructions that, when executed by the one or more processors, cause the one or more processors to:
train the discriminative network (i) in a first phase comprising a supervised training process, and (ii) a second phase comprising an unsupervised training process.

19. The computer device of claim 15, further comprising a display, and wherein the one or more non-transitory memories having stored thereon computer executable instructions that, when executed by the one or more processors, cause the one or more processors to display the generated response on the display.

20. The computer device of claim 15, wherein:
the discriminative network is a first discriminative network;
the at least one domain is a first at least one domain; and
the GAN further comprises a second discriminative network, wherein the second discriminative network was trained based on information of a second at least one domain, wherein the second at least one domain: (i) is different than the first at least one domain, and (ii) includes at least one of:
retirement;
cyber;
legal;
compliance;
human resources;
privacy; or
fairness.
